(19) United States
(12) Patent Application Publication
(10) Pub. No.: US 2026/0107343 A1
(43) Pub. Date: Apr. 16, 2026

(54) SELECTION OF OPERATIONAL MODES FOR DUAL MODE USER EQUIPMENT

(71) Applicant: Lenovo (United States) Inc., Morrisville, NC (US)

(72) Inventors: Hossein BAGHERI, Dearborn Heights, MI (US); Vijay NANGIA, Woodridge, IL (US); Karthikeyan GANESAN, Nauheim (DE)

(21) Appl. No.: 19/248,214

(22) Filed: Jun. 24, 2025

(51) Int. Cl. H04W 76/20; H04W 56/00; H04W 74/0833

(52) U.S. Cl. CPC H04W 76/20; H04W 56/0015; H04W 74/0833

(57) ABSTRACT

Various aspects of the present disclosure relate to configuring, selecting, or operating dual-mode user equipment (DUEs), such as mechanisms that facilitate the transitioning of operational modes for a DUE. For example, a DUE may select or otherwise determine, based on information (e.g., a selection metric) within a synchronization signal block (SSB), an operational mode to use when communicating with an NE, such as a base station or cell. The operational mode may include a low power wide area (LPWA) mode or a mobile broadband (MBB) mode.

### TECHNICAL FIELD

The present disclosure relates to wireless communications, and more specifically to the selection of operational modes for dual mode user equipment (UE).

### BACKGROUND

A wireless communications system may include one or multiple network communication devices, which may be otherwise known as network equipment (NE), supporting wireless communications for one or multiple user communication devices, which may be otherwise known as UE, or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including the claims, an article “a” before an element is unrestricted and understood to refer to “at least one” of those elements or “one or more” of those elements. The terms “a,” “at least one,” “one or more,” and “at least one of one or more”may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.

As used herein, including in the claims, a “set” may include one or more elements.

The present disclosure relates to methods, apparatuses, processors, and systems that provide mechanisms for dual mode UEs (DUEs), such as operational mode determination mechanisms, operational mode transition mechanisms, cell reselection for DUEs, synchronization signal monitoring for DUEs, and so on.

A UE for wireless communication is described. The UE may be configured to, capable of, or operable to perform one or more operations as described herein. For example, the UE may comprise one or more memories and one or more processors coupled with the one or more memories and individually or collectively configured to cause the UE to detect a synchronization signal block (SSB) associated with a network entity, determine, based on a selection metric associated with the SSB, an operational mode for the UE, and communicate with the network entity via the determined operational mode.

A processor for wireless communication is described. The processor may be configured to, capable of, or operable to perform one or more operations as described herein. For example, the processor may comprise one or more memories and one or more controllers coupled with the one or more memories and individually or collectively configured to cause the processor to detect an SSB associated with a network entity, determine, based on a selection metric associated with the SSB, an operational mode for the UE, and communicate with the network entity via the determined operational mode.

A method performed or performable by the UE is described. The method may comprise detecting an SSB associated with a network entity, determining, based on a selection metric associated with the SSB, an operational mode for the UE, and communicating with the network entity via the determined operational mode.

In some implementations of the UE, processor, and method described herein, the selection metric associated with the SSB includes an SSB acquisition time, an SSB index acquisition time, or a cell search time.

In some implementations of the UE, processor, and method described herein, the UE, processor, and method may further be configured to, capable of, performed, performable, or operable to perform time and frequency synchronization based on the detected SSB, decode a master information block (MIB) from a physical broadcast channel (PBCH) based on the detected SSB, decode a system information block (SIB1) based on information from the PBCH and the determined operational mode, and determine a suitability of the network entity based on the PBCH, the SIB1, a signal quality for the network entity, and the determined operational mode.

In some implementations of the UE, processor, and method described herein, the UE, processor, and method may further be configured to, capable of, performed, performable, or operable to, when the network entity is a suitable cell for the determined operational mode, camp on the network entity and initiate communications in an idle mode, when the network entity is not a suitable cell for the determined operational mode, switch to a different operational mode.

In some implementations of the UE, processor, and method described herein, the operational mode for the UE includes a low power wide area (LPWA) operational mode or a mobile broadband (MBB) operational mode when the UE is in a radio resource control (RRC) idle mode or inactive mode.

In some implementations of the UE, processor, and method described herein, the UE, processor, and method may further be configured to, capable of, performed, performable, or operable to decode a first SIB1 based on information from a PBCH when the operational mode is the LPWA operational mode and decode a second SIB1, different from the first SIB1, based on information from the PBCH when the operational mode is the MBB operational mode.

In some implementations of the UE, processor, and method described herein, the UE, processor, and method may further be configured to, capable of, performed, performable, or operable to decode a first field in a SIB1 based on information from a PBCH when the operational mode is the LPWA operational mode and decode a second field in the SIB1, different from the first field in the SIB1, when the operational mode is the MBB operational mode.

In some implementations of the UE, processor, and method described herein, the UE, processor, and method may further be configured to, capable of, performed, performable, or operable to decode a SIB1 and a second SIB1 based on information from a PBCH, perform a random access channel (RACH) operation based on a first RACH configuration and first RACH resources determined from the first SIB1, determine the RACH operation has failed, and perform an additional RACH operation based on a second RACH configuration and second RACH resources determined from the second SIB1.

In some implementations of the UE, processor, and method described herein, the UE, processor, and method may further be configured to, capable of, performed, performable, or operable to decode a SIB1 based on information from a PBCH and perform a cell selection procedure based on cell selection parameters from the SIB1, wherein the cell selection parameters are associated with operational modes supported by the UE.

A network entity for wireless communication is described. The network entity may be configured to, capable of, or operable to perform one or more operations as described herein. For example, the network entity may comprise one or more memories and one or more processors coupled with the one or more memories and individually or collectively configured to cause the network entity to determine a UE is connected to the network entity in a first operational mode and transmit an indication to the UE to switch to a second operational mode different from the first operational mode.

A method performed or performable by the network entity is described. The method may comprise determining a UE is connected to the network entity in a first operational mode and transmitting an indication to the UE to switch to a second operational mode different from the first operational mode.

In some implementations of the network entity and method described herein, the network entity and method may further be configured to, capable of, performed, performable, or operable to flush data buffers associated with the first operational mode for the UE.

In some implementations of the network entity and method described herein, the indication includes an indication of a bandwidth partition (BWP) switch and a switching time for switching from the first operational mode to the second operational mode.

In some implementations of the network entity and method described herein, the first operational mode is an LPWA operational mode and the second operational mode is a MBB operational mode.

In some implementations of the network entity and method described herein, the indication includes an indication of a switching time to the MBB mode.

In some implementations of the network entity and method described herein, the first operational mode is a MBB operational mode and the second operational mode is an LPWA operational mode.

In some implementations of the network entity and method described herein, the indication includes an indication of a switching time to the LPWA operational mode.

In some implementations of the network entity and method described herein, the network entity and method may further be configured to, capable of, performed, performable, or operable to transmit the indication in a PBCH of an SSB, wherein the SSB includes: a first SIB1 associated with the first operational mode and a second SIB1, different from the first SIB1, associated with the second operational mode.

In some implementations of the network entity and method described herein, the indication includes information barring UEs configured to operate only in the first operational mode.

### BRIEF DESCRIPTION OF THE DRAWINGS

FIG. 1 illustrates an example of a wireless communications system in accordance with aspects of the present disclosure.

FIG. 2 illustrates an example of signaling between an NE and a UE in accordance with aspects of the present disclosure.

FIG. 3 illustrates an example of control resource set monitoring by a DUE in accordance with aspects of the present disclosure.

FIG. 4 illustrates an example of signaling between an NE and a UE in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

FIG. 10 illustrates a flowchart of a method performed by an NE in accordance with aspects of the present disclosure.

FIG. 11 illustrates a flowchart of a method performed by an NE in accordance with aspects of the present disclosure.

### DETAILED DESCRIPTION

A wireless communications system, such as one that supports or provides wireless communications across one or more radio access technologies including 6G, may support UEs of different types or operational modes. In some examples, wireless communications systems may support UEs that communicate via the LPWA operational mode (or other low power or wide area modes), the MBB (e.g., eMBB) operational mode, and so on.

The wireless communications system may facilitate a common or universal communications environment for all UEs (e.g., between UEs having different or distinguished characteristics or capabilities, such as different coverages, different bandwidths, different battery lives, and so on), in order to promote energy saving, network fragmentation, and so on.

Some UEs may be DUEs, where the UEs can operate in a dual (or multiple) mode, such as the LPWA and MBB operational modes. A DUE may operate in an MBB (e.g., eMBB) mode during normal network conditions and in an LPWA mode during certain reduced conditions (e.g., reduced conditions that arise from a remote location having few access points, a low battery level for a UE, and so on). For example, when the DUE is in a remote area and/or has a low battery, the DUE may operate in the LPWA mode, otherwise the DUE (e.g., having suitable coverage and/or a sufficient charge) operates in the MBB mode.

The present disclosure introduces mechanisms for configuring, selecting, or operating DUEs, such as mechanisms that facilitate the transitioning of operational modes for a DUE. For example, a DUE may select or otherwise determine, based on information (e.g., a selection metric) within an SSB (e.g., within a SIB1) an operational mode (e.g., MBB, LPWA, coverage extension, ultra reliable low latency communications (URLLC), and so on) to use when communicating with an NE, such as a base station or cell. In some cases, the NE may transmit an indication associated with a preferred or requested operational mode to the UE, such as barring information for one or more operational modes, information that causes the DUE to switch between operational modes, and so on.

Thus, the present disclosure introduces signaling mechanisms associated with determining an operational mode for a UE in an RRC idle mode and/or an RRC connected modes, transitions between operational modes (e.g., from MBB to LPWA), the monitoring of a SIB1 (or other SSB information), cell selection or reselection procedures, and so on). In doing so, the wireless communications system may support and/or enhance the use of UEs capable of employing two or more operational modes (e.g., modes of accessing a network and/or communicating over a network), such as DUEs.

Aspects of the present disclosure are described in the context of a wireless communications system.

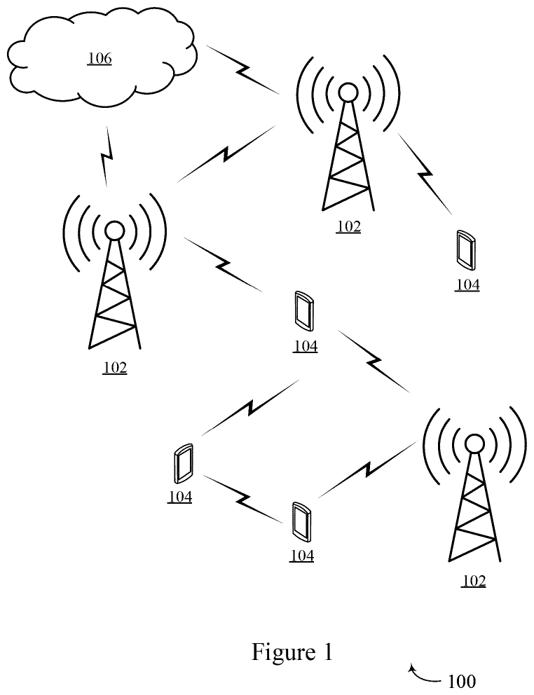

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1,μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively.

Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, one or more NE 102 may provision multiple sets of resources (e.g., time and frequency random access resources) to one or more UEs 104, where each set of resources of the multiple sets of resources is associated with selection criteria. By way of example, an NE 102 may determine selection criteria for each of one or more sets of resources of a plurality of sets of resources for random access, and transmit, to a UE 104, a configuration of the plurality of sets of resources for random access. The UE 104 may receive, from the NE 102, the configuration of the plurality of sets of resources for random access. In some examples, the UE 104 may select a set of resources of a plurality of sets of resources for random access based at least in part on criteria, and perform random access based at least in part on the selected set of resources.

As described herein, the wireless communications system 100 may implement various signaling mechanisms and procedures to enhance the use of DUEs within various network environments or communication scenarios, such as locations having poor cell coverage, low battery scenarios for the DUEs, and so on. For example, a DUE (or a similar user device that supports and can switch between operational modes) may be configured to select or utilize one operational mode over another operational mode based on information received from the NE 102 (e.g., a base station, such as a gNB, for a service cell or area), based on various characteristics for the DUE (e.g., a low battery level or other reduced capabilities), and so on.

In some cases, certain or various conditions may cause a DUE to select/determine the LPWA mode. A low battery level of the DUE and/or a small or remote coverage area may cause or trigger the DUE to switch from a normal or baseline operational mode (e.g., MBB mode to the LPWA mode. For example, a condition associated with a low battery level, but good suitable coverage, may cause the DUE to transition to the LPWA mode in order to reduce the operational bandwidth for the DUE.

As another example, a condition where the battery level and coverage are both low may cause the DUE to operate with a reduced bandwidth and perform multiple repetitions to enhance the coverage. Further, a condition where the battery level is high and the coverage is reduced may cause the DUE to perform the multiple repetitions, but maintain its operational mode as the MBB mode, possibly using a coverage extension mode.

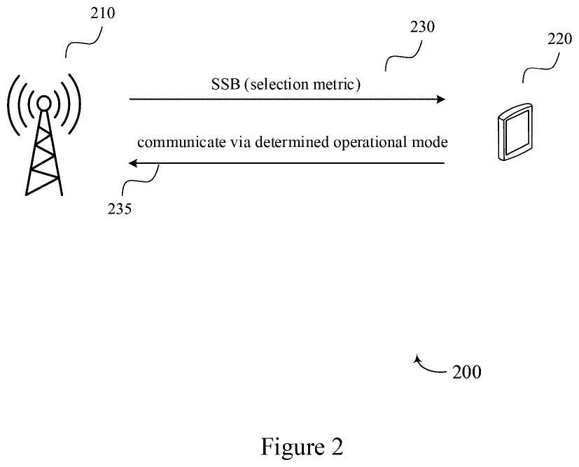

FIG. 2 illustrates an example of signaling between an NE 210 and a DUE 220 in accordance with aspects of the present disclosure. As described herein, the DUE 220, in some cases, is capable of and/or supports operating (e.g., accessing, communicating) in an LPWA mode and an MBB mode. The DUE 220 may acquire synchronization, such as by decoding a PBCH of an SSB (e.g., via either operational mode) for the NE 210.

The DUE 220 detects an SSB 230 associated with the NE 210. The SSB 230 may include a selection metric, such as a value, parameter, or other indicator that represents or indicates to the DUE 220 to select or determine an operational mode for use with the NE 210. Using the selection metric, the DUE 220 may determine an operational mode and communicate 235 with the NE 210 via the determined operational mode.

As described herein, the DUE 220 may determine the operational mode in an idle state or mode (e.g., an RRC idle or inactive mode) and/or a connected state or mode (e.g., an RRC connected or active mode).

In the idle mode, the DUE 220 detects a SIB1 from the SSB 230. Based on the detected SIB1, the DUE 220 may determine or detect an SSB parameter level and compare the parameter level with a threshold level (e.g., using the parameters ss-PBCH-BlockPower, Q-RxLevMin, and so on). The DUE 220 may initially operate in a default operational mode and then switch to a different operational mode (e.g., from MBB to LPWA) based on the comparison of the SSB signal or parameter to the threshold level. In some cases, the DUE 220 may perform the comparison and/or compute the SSB parameter or signal level within a certain time window or duration and/or a certain number of sample levels.

In some examples, the selection metric may include an SSB acquisition time (SSB-AT), an SSB index acquisition time (e.g., a time period used to acquire the index of the SSB being measured), and/or a cell search time (e.g., for PSS/SSS detection). Such metrics may be indicative of the coverage of an area or location served by the NE 210. For example, when the DUE 220 measures the SSB-AT to be larger than β, the DUE 220 may selected the LPWA mode as the operational mode and perform corresponding actions associated with the LPWA mode (e.g., monitoring a CORESET0 and/or reading an SIB1 associated with the LPWA mode). However, when the DUE 220 measures the SSB-AT to be less than β, the DUE 220 may select the MBB mode as the operational mode (e.g., the measurement indicating sufficient coverage for the NE 210).

In some cases, the threshold β (e.g., for a selection metric of a SSB index acquisition of 120 ms or a PSS/SSS detection time of 800 ms) may be pre-set or determined, and/or the threshold β may be specific for the DUE 220 (e.g., signaled by the NE 210 and/or indicated, such as via PBCH). In some cases, the DUE 220 may measure the selection metric (e.g., the SSB-AT) and an associated threshold β in an absolute time manner (e.g., 100 ms), in a number of time slots, in a number of SSB samples, as a function of SSB samples and SSB periodicity, and so on. In some cases, the threshold β may be set or dependent on knowledge of the NE 210 (e.g., the cell may be an unknown intra-frequency cell in FR1) and may be specific for each FR of the cell.

In some examples, such as when the DUE 220 may not satisfy RAN4 requirements for SSB detection (e.g., timing parameters), the DUE 220 may automatically switch to the LPWA mode. Thus, the DUE 220 may select and/or determine the LPWA mode based on SSB detection parameters (e.g., when the DUE 220 does not satisfy a first SSB timing), a number of detected neighbor cells being below a threshold, a number of SSB beams per measurement period being below a threshold, and so on.

For example, the DUE 220 may select or switch to the LPWA mode when a 1^{st} SSB timing/number of detected neighbor cells/number of SSB beams per measurement period cannot be satisfied and/or a 2^{nd} SSB timing/number of detected neighboring cells/number of SSB beams per measurement period cannot be satisfied (e.g., also indicating the DUE 220 is out of coverage or a failed cell reselection procedure has occurred). Thus, in some cases, the DUE 220 switches to the LPWA mode when it cannot satisfy a first set of RAN4 requirements and is determined to be out of coverage and/or has failed in cell reselection when it cannot satisfy a second set of RAN4 requirements.

In some cases, the DUE 220 only monitors the LPWA-CORESET0 and the LPWA-SIB1 when the DUE 220 is in the LPWA mode while in idle mode and monitor both (1) the LPWA-CORESET0 and the LPWA-SIB1 and (2) the MBB-CORESET0 and the MBB-SIB1 when in the MBB mode (and in the idle mode).

In the connected mode, the NE 210 may indicate a switching of operational modes by the DUE 220. For example, the NE 210 may, based on some measurements (e.g., a sounding reference signal (SRS)) or feedback from the DUE 220 (e.g., an explicit indication from the DUE 220 requesting a switch or an implicit indication (e.g., several consecutive negative acknowledgments (NACKs)), send an indication to cause the DUE 220 to switch to the LPWA mode.

In some cases, such as when the DUE 220 does not receive an uplink grant in response to a scheduling request (SR) after a certain number of transmissions (e.g., maxSRTransmissions, the DUE 220 may determine the SR procedure has failed and trigger a random access (RA) procedure. For example, the DUE 220 may use RACH resources or a RACH configuration corresponding to the MBB mode (e.g., when the battery level or coverage level is good or suitable) or use RACH resources and a RACH configuration for the LPWA mode (e.g., when the battery level or coverage level (e.g., SSB-AT>β) is small or reduced. In some cases, the DUE 220 may decode a SIB1 to determine or identify the RACH configuration for the LPWA mode. Further, there may be measurement gaps and/or gap configurations for each of the operational modes.

In some examples, the DUE 220 receives a mode transition indication from the NE 210 and/or determines to switch operational modes (e.g., by a certain time period). In an idle or inactive mode, the DUE 220 may determine the operational mode after the detection of the SSB 230. Based on the selection metric (e.g., the SSB-AT), the DUE 220 may begin procedures based on the determined operational mode.

For example, when the DUE 220 selects the LWPA mode, the DUE 220 monitors an LPWA-CORESET0 and decodes an LPWA-SIB, and when the DUE 220 selects the MBB mode, the DUE 220 monitors an MBB-CORESET0 and decodes an MBB-SIB1. As another example, when the DUE 220 performs a RACH procedure according to an MBB-RACH configuration and cannot perform a successful RACH within a defined period of time or after a defined number of attempts, the DUE 220 may transition into the LPWA mode.

When the DUE 220 is in a connected or active mode (e.g., RRC connected mode), a BWP switching framework may facilitate the selection or switching of the operational mode of the DUE 220. For example, a default BWP may be set to an LPWA maximum bandwidth (e.g., 12 RBs). The NE 210 may send an indication to the DUE 220 to transition to the default BWP (e.g., via RRC/medium access control (MAC)/downlink control information (DCI) signaling), such as via switching indications (e.g., DCI-based or RRC-based indications). In some cases, the BWP switching framework may be used in an RRC connected mode, where a default BWP or an initial BWP may be associated with the LPWA mode.

In some cases, the BWP switching indication (e.g., DCI) may indicate a timeline from a set of timelines (e.g., the set contains two timelines for BWP switching. One timeline may be associated with the DUE 220 not transitioning from the MBB mode to the LPWA mode or from the LPWA mode to the MBB mode. Another timeline may be associated with the DUE 220 transitioning from the MBB mode to the LPWA mode or from the LPWA mode to the MBB mode. The BWP switching indication may implicitly/explicitly indicate a switching to the LPWA/MBB operational mode (and may therefore define the behavior of the DUE 220).

In some cases, the DUE 220 may reset its L2/L3 protocol layer stack under various conditions when transitioning to the LPWA mode, such as when in an ultra-lean RRC connected or non-RRC connected state for the LPWA mode, an RRC reconfiguration, the release of one or more L2 entities (e.g., MAC, radio link control (RLC), packet data convergence protocol (PDCP) configurations), the flushing of buffers (e.g., data buffers are flushed or cleared and/or in-flight/queued data may be discarded), and so on.

In some cases, the DUE 220 may receive a 1^{st} higher layer indication (e.g., RRC/MAC) that indicates the DUE 220 is transitioning from a normal or default mode (e.g., the MBB mode) to the LPWA mode. Upon reception of the indication, the DUE 220 applies related configurations for the LPWA mode within a 1^{st} defined timeline (e.g., 30 ms). The DUE 220 may receive a 2^{nd} higher layer indication (RRC/MAC) that indicates that the DUE 220 is transitioning from the LPWA mode to a normal mode (e.g., the MBB mode). Upon reception of the indication, the DUE 220 applies related configurations for the normal mode within a 2^{nd} defined timeline (e.g., 5 ms). Thus, the timeline may be associated with or based on the operational mode to which the DUE 220 is transitioning.

When the DUE 220 receives a mode transition indication or determines a mode transition (e.g., from the normal/MBB mode to the LPWA mode), the DUE 220 may stop other running timers (e.g., a timer associated with transition to a default BWP).

In some cases, the DUE 220 performs reference signal received power (RSRP) or SSB measurements, and when no signal (e.g., SSB or PBCH) is detected within a defined period, the DUE 220 may switch to the LWPA mode. When the DUE 220 starts (e.g., wakes up) in the LWPA mode and later detects the SSB (or connects to the NE 210), the DUE 220 may transition to the MBB mode. When the RSRP or the SSB signal strength are higher than a threshold value, the DUE 220 may start monitoring SSBs of neighbor cells, stop the CORESET0 monitoring for the LPWA mode, and start monitoring the CORESET0 for the MBB mode.

For example, when the DUE 220 is in the MBB mode and the SSB-AT>β, the DUE 220 transitions from an MBB idle mode to an LPWA idle mode and performs operations associated with the LPWA mode (in the idle mode). The DUE 220 stays in the LPWA mode after transitioning from an idle mode to a connected mode until receiving an indication from the NE 210 to transition to the MBB mode (or based on other mode switching triggers or indications).

In some cases, such as when the DUE 220 connects to a cell in the LPWA mode and the DUE 220 receives an indication from the NE 210 to transition to the MBB mode, the DUE 220 may receive all associated configurations for an MBB operation (e.g., MBB-CORESET0 or other configurations provided by the MBB-SIB1). Likewise, when the DUE 220 connects to a cell in the MBB mode and the DUE 220 receives an indication from the NE 210 to transition to the LWPA mode, the DUE 220 may receive all associated configurations for an LPWA operation (e.g., LPWA-CORESET0 or other configurations provided by the LPWA-SIB1). As described herein, the DUE 220 may transmit an indication to the NE 210 to switch its operational mode.

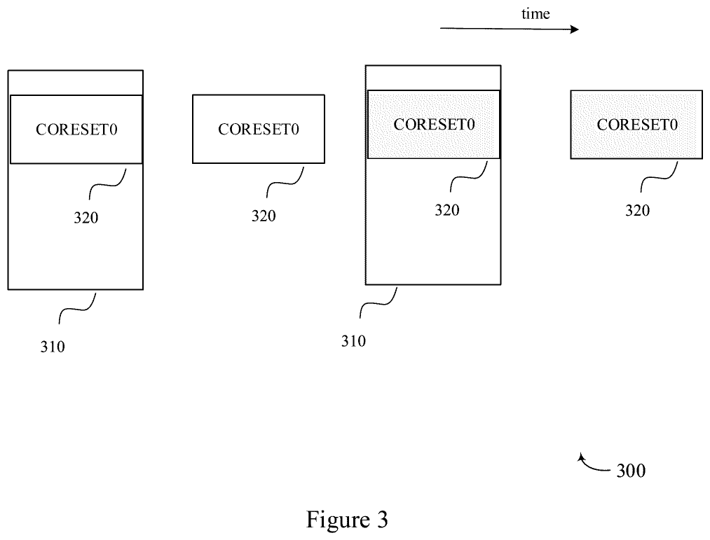

In some examples, the DUE 220 may monitor a CORESET0 based on its determined or selected operational mode. FIG. 3 illustrates an example of control resource set monitoring 300 by the DUE 220 in accordance with aspects of the present disclosure. The DUE 220 may monitor a 1^{st} CORESET0 310 scheduling a 1^{st} SIB1 physical downlink shared channel (PDSCH) when in the MBB mode and monitor a 2^{nd} CORESET0 320 scheduling a 2^{nd} SIB1 PDSCH when in the LPWA mode. The 1^{st} SIB1 may indicate a 1^{st} initial DL(UL) BWP configuration and the 2^{nd} SIB1 may indicate a 2^{nd} initial DL(UL) BWP configuration. In some cases, the DUE 220 monitors both CORESETs (e.g., the CORESET0 310 and the CORESET0 320) and decodes both SIB1s (e.g., in the MBB mode).

In some examples, the DUE 220 may operate based on a SIB1 acquisition timing being within a threshold time. For example, the time between a first SSB reception and a SIB1 decoding confirmation may be: (1) less than a 1^{st} threshold (T1) when a UE is a single mode MBB UE (e.g., the UE 104), (2) less than a 2^{nd} threshold (T2) when the DUE is a single mode LPWA UE, and (3) less than a 3^{rd} threshold (T3) when the UE is the DUE 220 or can otherwise operate in dual (or multiple) modes. In some cases, T3>T2 and T1, and T2>T1.

In some cases, a single mode MBB UE monitors an MBB-CORESET0 within a 1^{st} time window (e.g., less than a few (5) ms) after completing a PBCH decoding, a single mode LPWA UE monitors an LPWA-CORESET0 within a 2^{nd} time window after completing a PBCH decoding, and the DUE 220 monitors the MBB-CORESET0 within the 1^{st} time window (when in the MBB mode) and monitors the LPWA-CORESET0 within the 2^{nd} time window after completing the PBCH decoding when in the LPWA mode.

In some cases, the DUE 220 may monitor the MBB-CORESET0 within the 1^{st} time window (when in the MBB mode) and monitor the LPWA-CORESET0 within a 3^{rd} time window after completing the PBCH decoding when in the MBB mode, where the 3^{rd} time window is longer or greater than the 2^{nd} time window. In some cases, the DUE 220 may monitor the LPWA-CORESET0 within a 3^{rd} time window after completing the PBCH decoding when in the LPWA mode, where the 3^{rd} time window is longer or greater than the 2^{nd} time window.

In some examples, the DUE 220 may monitor a physical downlink control channel (PDCCH) in a 1^{st} CORESET0 scheduling a 1^{st} SIB1 PDSCH, where the 1^{st} SIB1 indicates a 1^{st} and 2^{nd} initial DL(UL) BWP configurations. The DUE 220 may use the 1^{st} initial BWP during the MBB mode and transitions to the 2^{nd} initial DL BWP during the LWPA mode.

In some cases, the SIB1 may include initial values for one or more RRC connection setup timers, including a T300 timer (e.g., wait for RRC Connection Setup) and a T301 timer (e.g., wait for RRC Connection Reestablishment). The DUE 220, in the MBB mode, may monitor the MBB-SIB1 to obtain the initial timer values, and, in the LWPA mode, monitor the LPWA-SIB1 to obtain the initial timer values. In some cases, the DUE 220 may monitor (in the MBB mode) both the LPWA-SIB1 and the MBB-SIB1 to obtain the initial timer values corresponding to each operational mode and/or only monitor the SIB1 that corresponds to its current operational mode.

As described herein, the DUE 220 may perform cell reselection procedures based on its operational mode. For example, the SIB1 may broadcast parameters related to selection criteria (S-criteria), such as different parameters for each operational mode. The DUE 220 may the LPWA-SIB1 and/or the MBB-SIB1 and apply LPWA-S-Criteria before determining the suitability of a cell (e.g., for reselection).

In the idle/inactive mode, the DUE 220 may periodically searche for neighbor SSBs and measure their SS-RSRPs against the reselection criteria. For inter-frequency scanning, the DUE 220 may capture the SSB within a time period, which may be specific to the operational mode (e.g., a time period for the LWPA mode and a time period for the MBB mode).

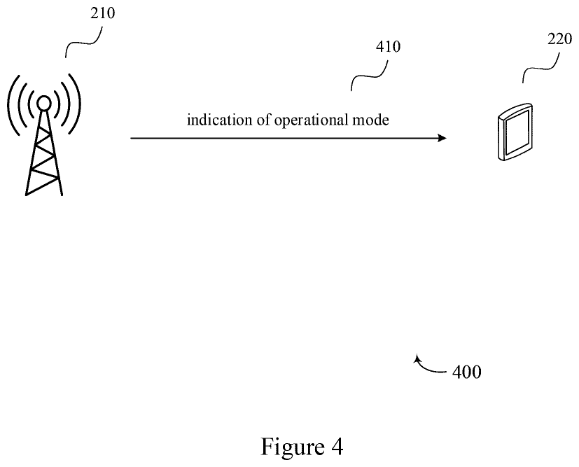

As described herein, the NE 210 may transmit an indication to select an operational mode and/or switch to a second operational mode different from a first operational mode. FIG. 4 illustrates an example of signaling 400 between the NE 210 and the DUE 220 in accordance with aspects of the present disclosure. As depicted, the NE 210 transmits an indication 410 of the operational mode to the DUE 220.

In some cases, the NE 210, via PBCH signaling, indicates one or more types of UEs (or operational modes) that are barred from the cell. For example, if LWPA modes are barred, the DUE 220 may not use the LPWA mode with the NE 210 and/or may not access or attach to the NE 210. The PBCH may indicate different barring scenarios, including the barring of normal UEs, LPWA UEs, normal UEs in the LPWA mode (e.g., the DUE 220), and so on. Further, the PBCH may include two indications, one for LPWA UEs and one for MBB UEs, where the DUE 220 may decode either or both indications. If barred, the DUE 220 may switch its operational mode to an unbarred (or available mode) or perform a cell reselection procedure, as described herein.

In some cases, measurement reporting (e.g., delays or disablement) may be based on the operational mode. In some cases, handover timers may be specific to the different operational modes.

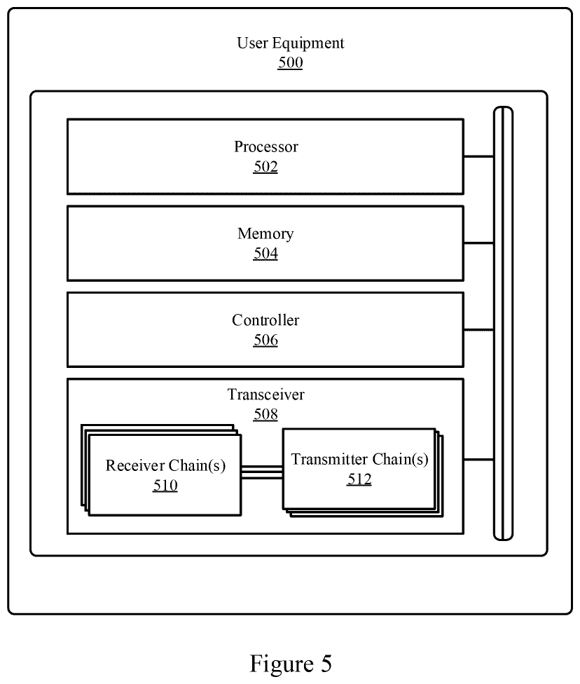

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for detecting an SSB associated with a network entity, determining, based on a selection metric associated with the SSB, an operational mode for the UE, and communicating with the network entity via the determined operational mode.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

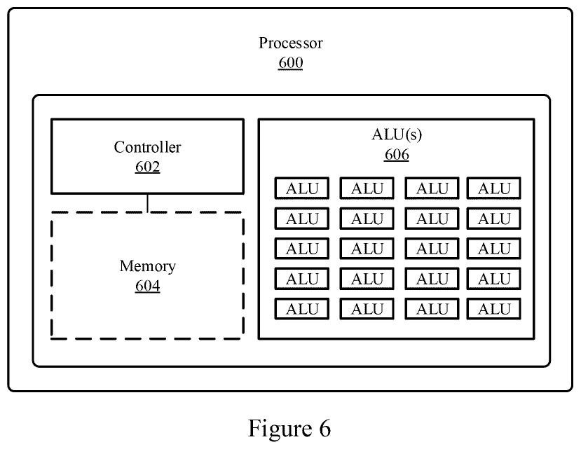

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. For example, the processor 600 may be configured to support a means for detecting an SSB associated with a network entity, determining, based on a selection metric associated with the SSB, an operational mode for the UE, and communicating with the network entity via the determined operational mode.

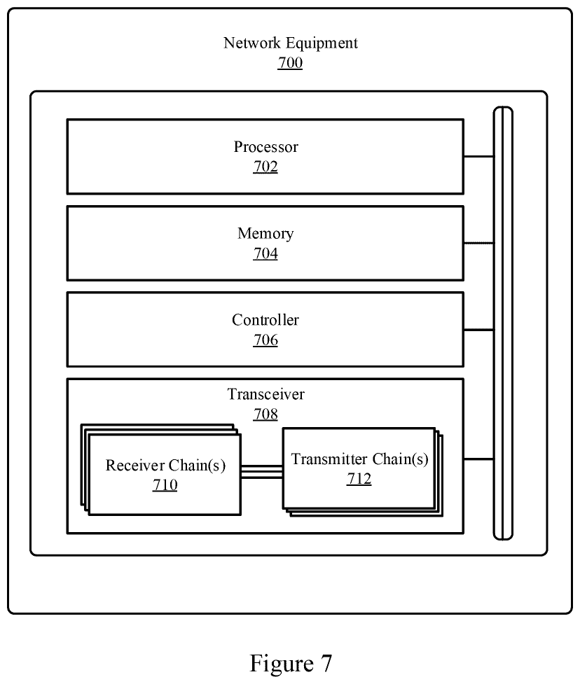

FIG. 7 illustrates an example of a NE 700 in accordance with aspects of the present disclosure. The NE 700 may include a processor 702, a memory 704, a controller 706, and a transceiver 708. The processor 702, the memory 504, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704).

For example, the processor 702 may support wireless communication at the NE 700 in accordance with examples as disclosed herein. The NE 700 may be configured to support a means for determining a UE is connected to the network entity in a first operational mode and transmitting an indication to the UE to switch to a second operational mode different from the first operational mode.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

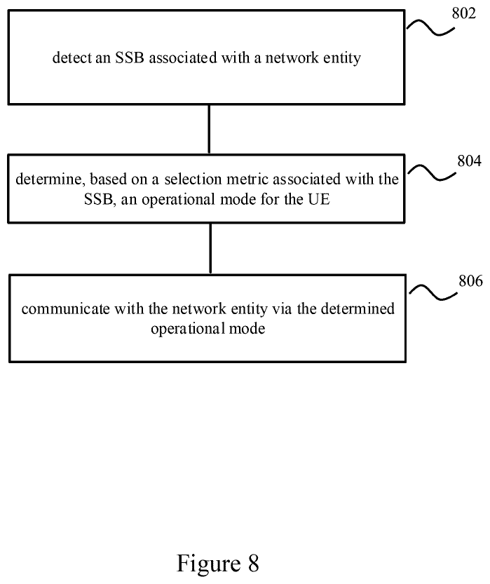

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include detecting an SSB associated with a network entity. The operations of 802 may be performed in accordance with examples as described herein. In some implementations, aspects of the operations of 802 may be performed by a UE as described with reference to FIG. 5.

At 804, the method may include determining, based on a selection metric associated with the SSB, an operational mode for the UE. The operations of 804 may be performed in accordance with examples as described herein. In some implementations, aspects of the operations of 804 may be performed by a UE as described with reference to FIG. 5.

At 806, the method may include and communicating with the network entity via the determined operational mode. The operations of 806 may be performed in accordance with examples as described herein. In some implementations, aspects of the operations of 806 may be performed by a UE as described with reference to FIG. 5.

It should be noted that the method described herein describes a possible implementation, and that the operations and the steps may be rearranged or otherwise modified and that other implementations are possible.

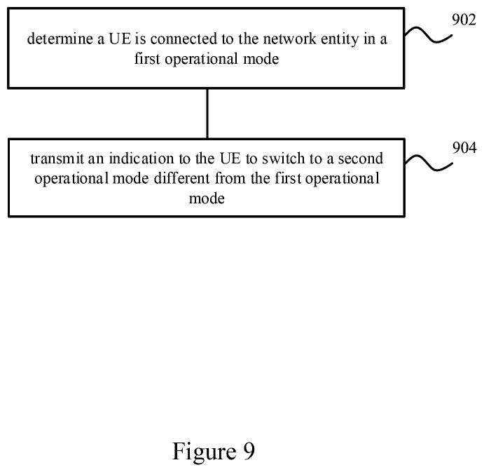

FIG. 9 illustrates a flowchart of a method in accordance with aspects of the present disclosure. The operations of the method may be implemented by an NE as described herein. In some implementations, the NE may execute a set of instructions to control the function elements of the NE to perform the described functions.

At 902, the method may include determining a UE is connected to the network entity in a first operational mode. The operations of 902 may be performed in accordance with examples as described herein. In some implementations, aspects of the operations of 902 may be performed by an NE as described with reference to FIG. 7.

At 904, the method may include transmitting an indication to the UE to switch to a second operational mode different from the first operational mode. The operations of 904 may be performed in accordance with examples as described herein. In some implementations, aspects of the operations of 904 may be performed by an NE as described with reference to FIG. 7.

It should be noted that the method described herein describes a possible implementation, and that the operations and the steps may be rearranged or otherwise modified and that other implementations are possible.

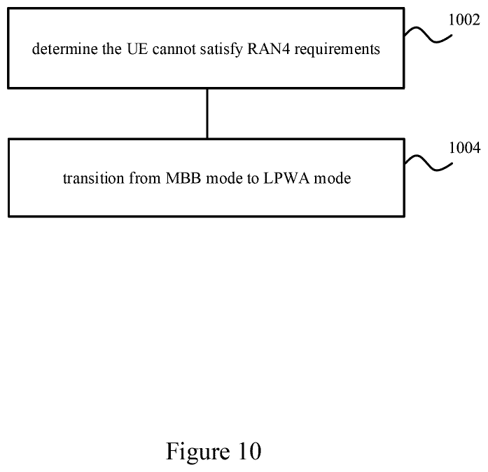

FIG. 10 illustrates a flowchart of a method in accordance with aspects of the present disclosure. The operations of the method may be implemented by a UE as described herein. In some implementations, the UE may execute a set of instructions to control the function elements of the UE to perform the described functions.

At 1002, the method may include determining a UE cannot satisfy a set of RAN4 requirements. The operations of 1002 may be performed in accordance with examples as described herein. In some implementations, aspects of the operations of 1002 may be performed by a UE as described with reference to FIG. 5.

At 1004, the method may include switching from an MBB mode to an LPWA mode. The operations of 1004 may be performed in accordance with examples as described herein. In some implementations, aspects of the operations of 1004 may be performed by a UE as described with reference to FIG. 5.

It should be noted that the method described herein describes a possible implementation, and that the operations and the steps may be rearranged or otherwise modified and that other implementations are possible.

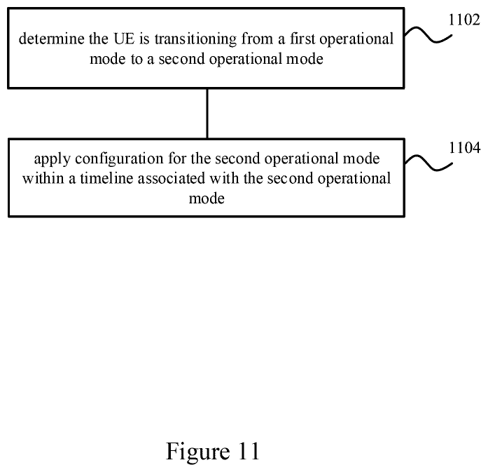

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions.

At 1102, the method may include determining a UE is transitioning from a first operational mode to a second operational mode. The operations of 1102 may be performed in accordance with examples as described herein. In some implementations, aspects of the operations of 1102 may be performed by a UE as described with reference to FIG. 5.

At 1104, the method may include applying a configuration for the second operational mode within a timeline associated with the second operational mode. The operations of 1104 may be performed in accordance with examples as described herein. In some implementations, aspects of the operations of 1104 may be performed by a UE as described with reference to FIG. 5.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
detect a synchronization signal block (SSB) associated with a network entity;
determine, based on a selection metric associated with the SSB, an operational mode for the UE; and
communicate with the network entity via the determined operational mode.

2. The UE of claim 1, wherein the selection metric associated with the SSB includes an SSB acquisition time, an SSB index acquisition time, or a cell search time.

3. The UE of claim 1, wherein the one or more processors are further individually or collectively configured to cause the UE to:
perform time and frequency synchronization based on the detected SSB;
decode a master information block (MIB) from a physical broadcast channel (PBCH) based on the detected SSB;
decode a system information block (SIB1) based on information from the PBCH and the determined operational mode; and
determine a suitability of the network entity based on the PBCH, the SIB1, a signal quality for the network entity, and the determined operational mode.

4. The UE of claim 3, wherein the one or more processors are further individually or collectively configured to cause the UE to:
when the network entity is a suitable cell for the determined operational mode, camp on the network entity and initiate communications in an idle mode; or
when the network entity is not a suitable cell for the determined operational mode, switch to a different operational mode.

5. The UE of claim 1, wherein the operational mode for the UE includes a low power wide area (LPWA) operational mode or a mobile broadband (MBB) operational mode when the UE is in a radio resource control (RRC) idle mode or inactive mode.

6. The UE of claim 5, wherein the one or more processors are further individually or collectively configured to cause the UE to:
decode a first system information block (SIB1) based on information from a physical broadcast channel (PBCH) when the operational mode is the LPWA operational mode; and
decode a second SIB1, different from the first SIB1, based on information from the PBCH when the operational mode is the MBB operational mode.

7. The UE of claim 5, wherein the one or more processors are further individually or collectively configured to cause the UE to:
decode a first field in a system information block (SIB1) based on information from a physical broadcast channel (PBCH) when the operational mode is the LPWA operational mode; and
decode a second field in the SIB1, different from the first field in the SIB1, when the operational mode is the MBB operational mode.

8. The UE of claim 1, wherein the one or more processors are further individually or collectively configured to cause the UE to:
decode a first system information block (SIB1) and a second SIB1 based on information from a physical broadcast channel (PBCH);
perform a random access channel (RACH) operation based on a first RACH configuration and first RACH resources determined from the first SIB1;
determine the RACH operation has failed; and
perform an additional RACH operation based on a second RACH configuration and second RACH resources determined from the second SIB1.

9. The UE of claim 1, wherein the one or more processors are further individually or collectively configured to cause the UE to:
decode a system information block (SIB1) based on information from a physical broadcast channel (PBCH); and
perform a cell selection procedure based on cell selection parameters from the SIB1,
wherein the cell selection parameters are associated with operational modes supported by the UE.

10. A network entity for wireless communication, comprising:
one or more memories; and
one or more processors coupled with the one or more memories and individually or collectively configured to cause the network entity to:
determine a user equipment (UE) is connected to the network entity in a first operational mode; and
transmit an indication to the UE to switch to a second operational mode different from the first operational mode.

11. The network entity of claim 10, wherein the one or more processors are further individually or collectively configured to cause the network entity to:
flush data buffers associated with the first operational mode for the UE.

12. The network entity of claim 10, wherein the indication includes an indication of a bandwidth partition (BWP) switch and a switching time for switching from the first operational mode to the second operational mode.

13. The network entity of claim 10, wherein the first operational mode is a low power wide area (LPWA) operational mode and the second operational mode is a mobile broadband (MBB) operational mode.

14. The network entity of claim 13, wherein the indication includes an indication of a switching time to the MBB mode.

15. The network entity of claim 10, wherein the first operational mode is a mobile broadband (MBB) operational mode and the second operational mode is a low power wide area (LPWA) operational mode.

16. The network entity of claim 15, wherein the indication includes an indication of a switching time to the LPWA operational mode.

17. The network entity of claim 10, wherein the one or more processors are individually or collectively configured to cause the network entity to transmit the indication in a physical broadcast channel (PBCH) of a synchronization signal block (SSB), wherein the SSB includes:
a first system information block (SIB1) associated with the first operational mode; and
a second SIB1, different from the first SIB1, associated with the second operational mode.

18. The network entity of claim 10, wherein the indication includes information barring UEs configured to operate only in the first operational mode.

19. A method performed by a user equipment (UE), the method comprising:
detecting a synchronization signal block (SSB) associated with a network entity;
determining, based on a selection metric associated with the SSB, an operational mode for the UE; and
communicating with the network entity via the determined operational mode.

20. A method performed by a network entity, the method comprising:
determining a user equipment (UE) is connected to the network entity in a first operational mode; and
transmitting an indication to the UE to switch to a second operational mode different from the first operational mode.
